(19) United States
(12) Patent Application Publication
(10) Pub. No.: US 2025/0111133 A1
(43) Pub. Date: Apr. 3, 2025

(54) MULTI-GRANULARITY MEETING SUMMARIZATION MODELS

(71) Applicants: Chenguang ZHU, Redmond, WA (US); Yang LIU, Redmond, WA (US); Nanshan ZENG, Bellevue, WA (US); Xuedong HUANG, Bellevue, WA (US); Ming ZHONG, Champaign, IL (US); Yuantao WANG, Redmond, WA (US); Wei XIONG, Redmond, WA (US); Microsoft Technology Licensing, LLC, Redmond, WA (US)

(72) Inventors: Chenguang Zhu, Redmond, WA (US); Yang LIU, Redmond, WA (US); Nanshan ZENG, Bellevue, WA (US); Xuedong HUANG, Bellevue, WA (US); Ming ZHONG, Champaign, IL (US); Yuantao Wang, Redmond, WA (US); Wei XIONG, Redmond, WA (US)

(21) Appl. No.: 18/834,200

(22) PCT Filed: Mar. 25, 2022
(86) PCT No.: PCT/CN2022/083072

§ 371 Date: Jul. 29, 2024

(51) Int. Cl. G06F 40/166

(52) U.S. Cl. CPC G06F 40/166

(57) ABSTRACT

Generally discussed herein are devices, systems, and methods for. A method can include receiving, from a user through a user interface, a segmentation granularity value indicating a number of events in the transcript to be included in a summary, extracting, by a ranker model and from the transcript, a number of hints equal to the number of events, generating, by a summarizer model that includes a re-trained language model, respective summaries, one for each event, of a portion of the transcript corresponding to the event, and providing the respective summaries as an overall summary of the transcript.

### BACKGROUND

Speech-to-text technology can provide a faithful record of what was said during a conference. Speech-to-text technologies use a computer to recognize and translate spoken language into text. The text can then be digested and searched in a non-audio format. Current speech-to-text technology simply provides a transcript of provided audio. The transcript typically includes every utterance including “ummm”, “uhhhh”, “like”, and other semantically nonce words that people commonly use.

### SUMMARY

A device, system, method, and computer-readable medium configured for multi-granularity transcript summarization are provided. The meeting summarization is variable and the variability can be controlled by a user, such as through an application programming interface (API), user interface (UI), or the like. The meeting summarization length can be controlled by providing topics (sometimes called “keywords” or “events”) to be summarized in the summary. A summarizer model can be trained to generate summaries based on input that define the content and length of the summary.

A method can include receiving, from a user through a user interface, a segmentation granularity value indicating a number of events in the transcript to be included in a summary. The method can include extracting, by a ranker model and from the transcript, a number of hints equal to the number of events. The method can include generating, by a summarizer model that includes a re-trained language model, respective summaries, one for each event, of a portion of the transcript corresponding to the event. The method can include providing the respective summaries as an overall summary of the transcript.

The method can include receiving, from the user through the user interface, a summary granularity value indicating a length of each of the respective summaries. The respective summaries can be generated, by the summarizer model and based on the summary granularity value, to have a length consistent with the summary granularity value. The method can further include receiving, from the user through the user interface, topic data indicating one or more events to be summarized. The respective summaries can be generated, by the summarizer model and based on the topic data, to cover the events indicated by the topic data.

The method can further include receiving, from the user through the user interface, speaker data indicating one or more speakers to be summarized. The respective summaries can be generated, by the summarizer model and based on the speaker data, to cover utterances made by the one or more speakers indicated by the speaker data. The method can further include receiving, from the user through the user interface, readability data indicating how fluent the overall summary is to be. The respective summaries can be generated, by the summarizer model, to be readable at a level indicated by the readability data. The readability data can indicate whether to remove filler words by identification and masking and whether to segment the transcript based on a ranking of the events.

The summarizer model can be trained by masking keywords in the transcript and having the summarizer model generate an unmasked transcript that fills in the masked keywords. The method can further include adjusting weights of the summarizer model based on differences between the transcript and the unmasked transcript to generate a pre-trained summarizer model. The method can further include fine-tuning the pre-trained summarizer model based on hints, the transcript, and pre-generated summaries. The hints can include two or more of readability data, topic data, speaker data, summary granularity value, and segmentation granularity value.

### BRIEF DESCRIPTION OF DRAWINGS

FIG. 1 illustrates, by way of example, a block diagram of an embodiment of a teleconference system.

FIG. 2 illustrates, by way of example, a block diagram of an embodiment of a system for multi-granularity meeting summarization.

FIG. 3 illustrates, by way of example, a block diagram of an embodiment of a system for training a summarizer model.

FIG. 4 illustrates, by way of example, a block diagram of an embodiment of a system for fine-tuning a pre-trained model.

FIG. 5 illustrates, by way of example, a block diagram of an embodiment of a system for event ranking,

FIG. 6 illustrates, by way of example, a block diagram of an embodiment of the user interface,

FIG. 7 illustrates, by way of example, a block diagram of an embodiment of a method for user-specified, multi-granularity summarization.

FIG. 8 is a block diagram of an example of an environment including a system for neural network training.

FIG. 9 illustrates, by way of example, a block diagram of an embodiment of a machine (e.g., a computer system) to implement one or more embodiments.

### DETAILED DESCRIPTION

Speech-to-text technology can provide an accurate record of what was said during a dialogue. A dialogue summarization system can generate a concise summary for a conversation, so users can quickly digest its content. Different readers tend to have different preferences about the granularity level of summarization. Embodiments provide a customizable dialogue summarization system. Embodiments allow a user to choose different summarization preferences on multiple dimensions. The multiple dimensions include one or more of readability, granularity, speaker, topic, a combination thereof or the like.

Regarding readability, the raw transcript is usually hard for a user to consume because the transcript is usually long and time consuming for people to read through, and the transcript is usually not as fluent as written text. As mentioned in the Background, people can add many filler words (e.g., “hmm”, “you know”, “yeah”, or the like) in their spoken language, or make corrections when they made some unintentional mistakes. The raw transcript does not have the corrections, but rather has the mistaken utterances and the words correcting the mistaken utterances.

A model or system of embodiments can fulfill different readability needs from users and make the transcript easier to consume. With the customizable dialogue summarization technology of embodiments, a user can choose the level of detail they want to read and zoom into the parts they are interested in. The levels can include Level 0, sometimes called raw transcription. The summary provides all the details said in the meeting; Level 1, sometimes called readable transcription. The summary includes filler words filtered out and the transcript is changed to a more readable format; and Level 2 etc., the summary is segmented at different detail levels chosen by a user. Note there is some overlap between the notion of readability and granularity, but the granularity controls a length of the summary while readability controls the content of the summary.

Granularity is a measure of the degree of semantic coverage between summary and source documents and the detailedness of the summary. Two aspects of granularity include the granularity of segmentation and the granularity of summarization. Since meeting transcripts are usually long, to generate the summary, the transcript can be segmented into multiple non-overlapping blocks of text. The non-overlapping blocks can be based on subject matter discussed according to the transcript, sometimes called topics. Then, for each topic, a human-readable summary of a defined length (e.g., defined by the user) can be generated.

On the segmentation level, higher granularity indicates more fine-grained segmentation. For example, if a user wants a lower granularity summary, embodiments can segment a meeting into a first specified number of parts; and for a user that wants a higher granularity, embodiments can segment the transcript into a second specified number of parts, greater than the first specified number of parts. On the summarization level, higher granularity indicates more detailed coverage of the meeting. In another example, for a user that requests a lower granularity summary, embodiments can provide a summary covering a first specified percentage of topics with simplified expressions; and for a user the requests a higher granularity summary, embodiments can provide a summary covering second specified percentage of topics with more detailed expressions. The second specified percentage is greater than the first specified percentage.

To achieve this, embodiments can extend a single-granularity dataset to a multi-granularity dataset, such as by leveraging a large neural language model. Embodiments can further include a neural summarization system that can take events/keywords/lengths as input, and generates a summary consistent with the events, keywords, and lengths. By training the summarization system on the multi-granularity dataset, embodiments can realize a meeting summarization system that can provide summaries at a variety of granularities.

In addition, or alternative, to readability or granularity, embodiments can filter a transcript based on speaker and specific topic. When using a granularity control, the user has control over how many topics are present in the summary, but not necessarily which topics are present in the summary. In some embodiments, the user can select specific topics to include in the summary. Multiple topics can be discussed in a conversation. When using the summarization system of embodiments, users might be interested in only some specific topics. Embodiments allows a user to provide or select several topic keywords, and the customizable summarization system will generate dialogue summaries for these keywords.

Similar to selecting the topics to be provided in the summary, the user can select one or more speakers. The speaker selection then focuses the model to concentrate on summarizing utterances by the selected speaker. Consider that, within a given dialogue, especially long meetings, there are usually multiple speakers, and it is often the case that the speakers play different roles in the dialogue. Embodiments allow a user to zoom into a specified subset of speakers to see more detailed summaries of the utterances made by those speakers. Consider a meeting in which Speaker A produced 40 utterances, and the summary for the meeting only covers two of those utterances. With the customizable dialogue summarization system of embodiments, a user can choose to receive a more detailed summary of utterances by Speaker A to see more detailed summaries (e.g., covering a specified number of utterances) which are specifically related to utterances by Speaker A.

While humans can provide summaries, teaching a computer to provide meaningful summaries with varying degrees of granularity is a great technical challenge. Some of the challenges include getting a computer to understand the semantic meaning of the transcript, including discourse information, meeting topics and intentions, getting the computer to generate fluent summaries that are human-readable, and since topics can be distributed in the transcript, providing the computer with the ability to compose these topics, rewrite them as a summary, and produce the concise and accurate summary of the topics. One or more of these challenges are overcome, in embodiments, by a new training technique described below. Further, the event ranker can provide a vector that indicates start and stop locations in the transcript that correspond to respective topics.

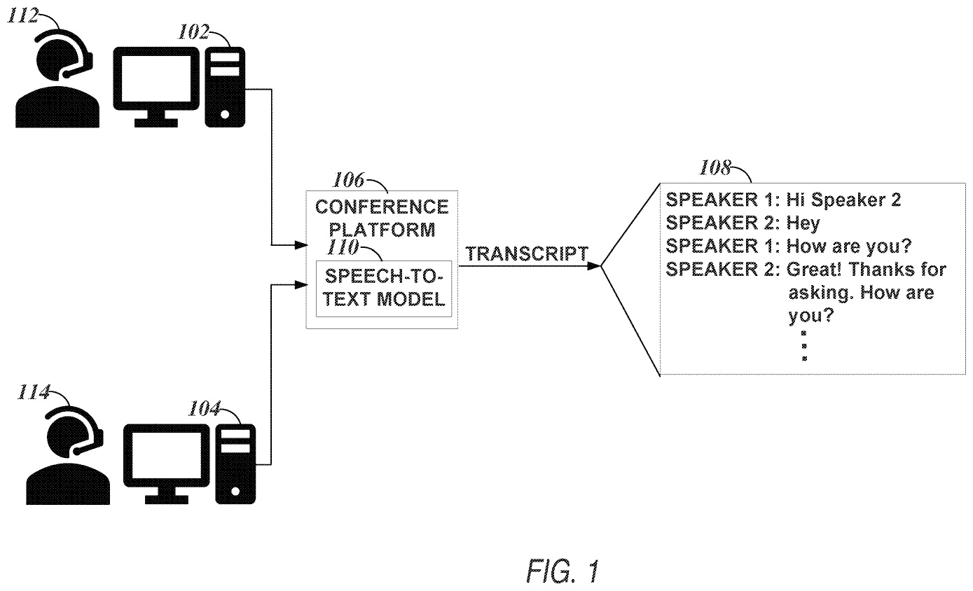

FIG. 1 illustrates, by way of example, a block diagram of an embodiment of a teleconference system 100. The scenario of FIG. 1 is common, but embodiments are not limited to transcripts of teleconferences. A manually generated transcript, such as from a court proceeding, a transcript generated for a live, in-person meeting, or other transcript of a conversation, are within the scope of embodiments.

The teleconference system 100 as illustrated includes user devices 102, 104 communicating over a teleconference platform 106. The teleconference platform 106, as illustrated, includes, or otherwise has access to a speech-to-text model 110. The speech-to-text model 110 converts utterances to text form in a transcript 108.

The user devices 102, 104 include compute devices capable of executing software for providing access to the conference platform 106 and providing audio, video, or a combination thereof, of the teleconference to a user 112, 114. The user devices 102, 104 can include a laptop computer, desktop computer, tablet, smartphone, or other compute device.

The conference platform 106 includes a server or other compute device that provides teleconference functionality. The conference platform 106 can provide functionality of, for example, Teams® from Microsoft Corporation of Redmond, Washington, Zoom® from Zoom Video Communications, Inc. of San Jose, California, Facetime® from Apple Inc. of Cupertino, California, WebEx from Cisco of Milpitas, California, GoToMeeting from LogMeIn Inc. of Boston, Massachusetts, Google Meet from Google of Mountain View, California, among many others.

The speech-to-text model 110 generates a text version of audio captured by the conference platform 106. The speech-to-text model 110 can be a discrete application or an integral part of the conference platform 106. The speech-to-text model 110 can include a Hidden Markov Model (HMM), a feedforward neural network (NN), long short-term memory (LSTM) or other recurrent NN (RNN), Gaussian mixture model (GMM), dynamic time warping (DTW), time delay NNs (TDNNs), denoising autoencoder, connectionist temporal classifier (CTC), attention-based network, a combination thereof, or the like.

The transcript 108 includes a screenplay style presentation of the utterances made during a conference on the conference platform 106. The transcript 108 includes a speaker identification and a text format version of the utterances made by the speaker. The text in the transcript 108 is, in general, in chronological order. There are some exceptions to chronological order, such as if a second speaker interrupts or otherwise speaks concurrently with a first speaker. Some transcript tools will perform speaker recognition and provide text that is continuous until the first speaker pauses their speech and then put the text corresponding to the utterances of the second speaker after that of the first speaker in the transcript 108.

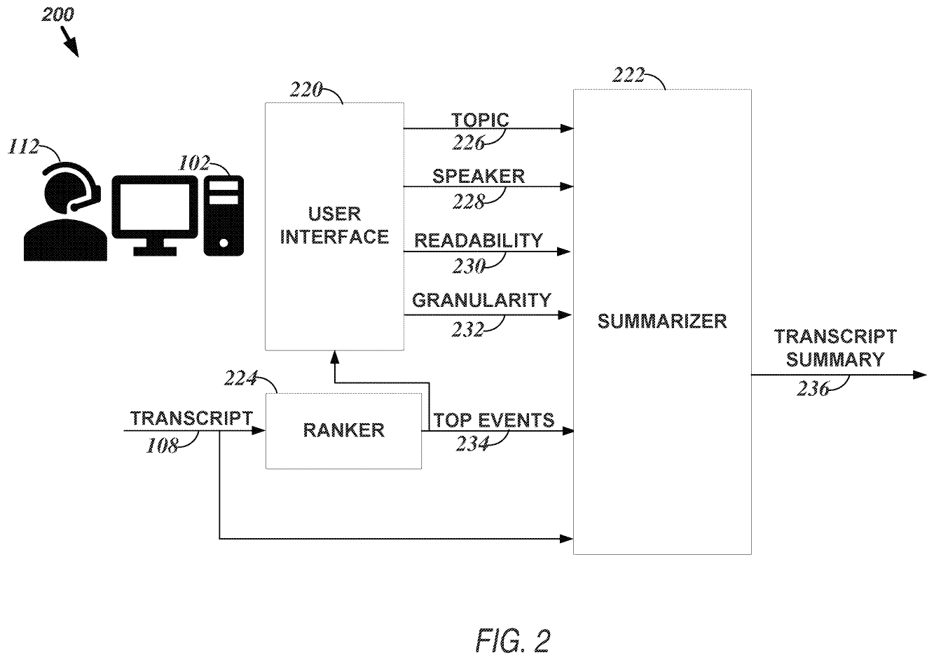

FIG. 2 illustrates, by way of example, a diagram of an embodiment of a system 200 for multi-granularity meeting summarization. The system 200 as illustrated includes a user interface 220 (accessible by a user 112 through a compute device 102) coupled to a summarizer 222 that includes a re-trained language model, and a ranker 224 coupled to the summarizer 222. The summarizer 222 receives the transcript 108 and provides a transcript summary 236 consistent with a user-provided parameter, such as a topic 226, speaker 228, readability 230, granularity 232, or a combination thereof. The summarizer 222 can generate the summary in an auto-regressive manner. A beam search technique can be implemented by the summarizer 222 in generating the summary.

The user interface 220 is an application that presents data in a visually coherent manner to the user 112. The user interface 220 can receive input from the user 112 and convert the input into a form compatible with the summarizer 222. The user interface 220 can present software controls, such as a menu, textbox, buttons, or other input controls, that allow the user to specify the type of summary to be produced by the summarizer 222.

The ranker 224 can analyze the transcript 108 and generate a list of top events 234 in the transcript 108. The ranker 224 can be a model of a class of models called “event rankers”. The top events 234 can be individual words, phrases, or a combination thereof. The ranker 224 can perform keyword extraction, sometimes called keyword detection or keyword analysis. Keyword extraction is a text analysis technique that automatically extracts the most used and most important words and expressions from a text. Keyword extraction helps identify the main topics discussed in the transcript 108. The top events 234 from the ranker 224 are words or expressions that are present in the transcript 108. There are many different techniques for automated keyword extraction that can be implemented by the ranker 224. These techniques include statistical approaches that count word frequency and supervised learning models. Statistical approaches include word frequency, term frequency-inverse document frequency (TF-IDF), rapid automatic keyword extraction (RAKE), n-gram statistics (word co-locations), part of speech (POS), a graph-based approach (e.g., TextRank Model or the like), a combination thereof, or the like. These approaches do not use training and operate based on statistical occurrence of words or expressions in the transcript 108. Supervised training-based approaches to ranking includes machine learning (ML) techniques, Support vector machine (SVM), deep learning, conditional random fields (CRF), or the like, are examples of ML based keyword extraction techniques. Some ranking techniques, that can be implemented by the ranker 224, can include a combination of statistical and supervised learning.

The topic 226 specifies a keyword or expression (sometimes called a phrase) that the user 112 would like in the summary 236. The user interface 220 can display a list of topics covered in the transcript 108. The user interface 220 can be coupled to the ranker 224 to receive the top events 234. The user interface 220 can provide the top events (or a subset thereof) to the user 112. The user 112 can select or specify one or more of the topics 226 for inclusion in the summary 236. The user 112 can select none of the topics 226 in some instances. The summarizer 222, in such instances, will provide the summary 236 based on the ranking of the top events 234 provided by the ranker 224.

The speaker 228 specifies an entity that provided an utterance that was converted to text in the transcript 108. Each unique speaker 228 can be extracted from the transcript 108 and provided to the user 112 through the user interface 220. The summarizer 222, the ranker 224, or another application or component can provide the unique speakers to the user interface 220. The user 112 can select or specify one or more of the speakers 228 to summarize. The summarizer 222 can filter the transcript 108 to just those utterances related to the speaker 228 and provide the summary 236 based on the filtered transcript.

The readability 230 specifies how much processing is performed in making the summary 236 read less like a transcript and more like a book. The raw transcript 108 is typically hard to consume because it is long, disjointed, not a fluent as written text, includes filler words (e.g., “ummmm”, “uhhhh”, “like”, “yeah”, “you know”, or the like that are present but do not add to the discourse), or a combination thereof, The readability 230 can be specified in a number of ways, The user 112 can select a level of readability 230 in which a higher (or lower if negative logic is used) level indicates a more fluent summary 236. A more fluent summary means filler words are removed and the transcript 108 is segmented by topic.

The granularity 232 specifies a degree of semantic coverage between the summary 236 and the transcript 108 and the amount of detail in the summary 236. Granularity 232 can be specified at one or more levels. The granularity 232 can be specified at a topic level (segment) and a summarization level. The topic level indicates a number or percentage of topics to be included in the summary 236. The summary level indicates a length (amount of detail) of the summary for each topic.

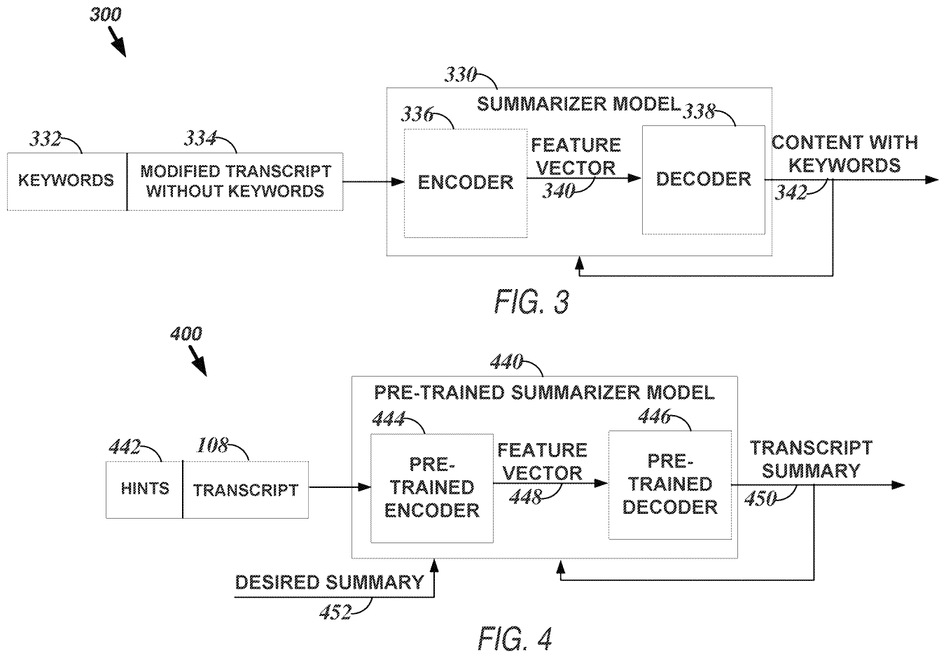

FIG. 3 illustrates, by way of example, a diagram of an embodiment of a system 300 for training a summarizer model 330. The summarizer model 330, after training, can be deployed as the summarizer 222. The summarizer model 330 can include a neural network (NN), such as a large language model (LM). The summarizer model 330 receives input that includes keywords 332 and modified versions of transcripts 334 that do not include the keywords 332. The transcripts 334 can have any sentences that include any of the keywords 332 deleted therefrom or masked.

An encoder 336 of the summarizer model 330 converts the input the keywords 332 and modified transcript 334) into a feature vector 340. The encoder 336, in general, performs dimensionality reduction on the input. The encoder 336 provides the feature vector 340 (sometimes called the “hidden state” of the input) to the decoder 338. The feature vector 340 contains information that represents the input in a lower dimension than the input.

The decoder 338 of the summarizer model 330 converts the feature vector 340 into an output space, which, in embodiments, is the same dimensionality as the input space. The decoder 338 attempts to generally reconstruct the transcript 108 based on the feature vector 340. The actual output 342 of the decoder 338 will likely be different from the transcript 108. Loss between the output 342 and the transcript 108 can be used to update weights of the summarizer model 330 to improve model accuracy or other performance metric. The training technique is a self-supervised masking technique with more advanced masking toward granularity.

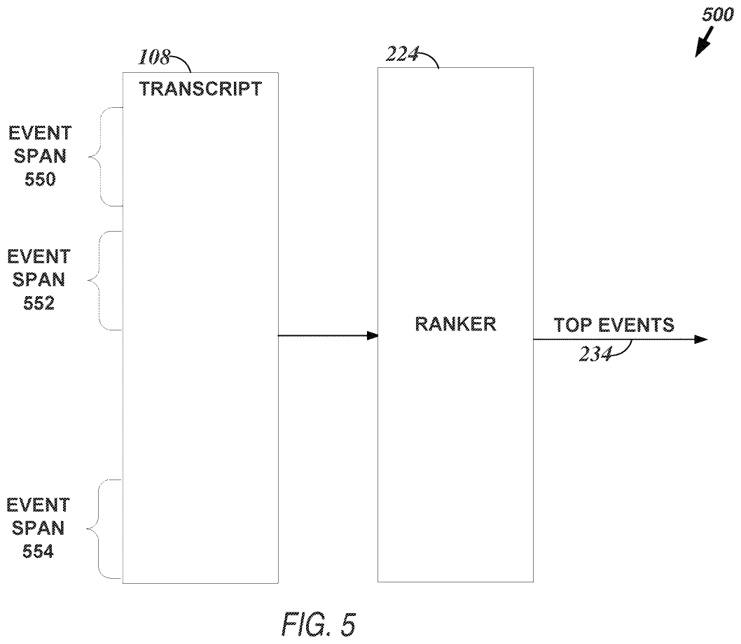

FIG. 4 illustrates, by way of example, a diagram of an embodiment of a system 400 for fine-tuning a pre-trained model 440. The pre-trained model 440 is the summarizer model 330 after initial training on multiple transcripts described regarding FIG. 3. The pre-trained summarizer model 440 includes a pre-trained encoder 444 (the encoder 336 after training using the system 300) and a pre-trained decoder 446 (the decoder 338 after training using the system 300). Fine-tuning can be performed using annotated data that includes hints 442 and the transcript 108. The hints 442 can include the topic 226, speaker 228, readability 230, granularity 232, or a combination thereof. A desired summary 452 includes summaries of segments of the transcript 108. Each segment is a topic of the transcript that spans a specified portion of the transcript (see FIG. 5), Each segment of the desired summary 452 can be aligned with a topic, speaker, or the like, in the hints 442. The pre-trained summarizer model 440 thus learns to generate a transcript summary 450 that includes sub-summaries that are aligned with one or more hints 442. Each of the sub-summaries can be of a same or a different length depending on the user 112 choices or default parameters of the pre-trained summarizer model 440. The feature vector 448 is the same as the feature vector 340 but is produced by the pre-trained encoder 444 instead of the encoder 336 before training. Loss between the transcript summary 450 and the desired summary 452 can be used to update weights of the pre-trained summarizer model 440 to improve model accuracy or other performance metric.

FIG. 5 illustrates, by way of example, a diagram of an embodiment of a system 500 for event ranking. The system 500 as illustrated includes the transcript 108 segmented into event spans 550, 552, 554. The event spans 550, 552, 554 are separate topics within the transcript 108 and a corresponding duration of the topic in the transcript 108. The event spans 550, 552, 554 can be provided as an input feature vector to the ranker 224. The span (e.g., number of utterances, number of lines consumed by the topic in the transcript 108, number of words uttered and associated with the topic in the transcript 108, or the like) can influence the rank. In some embodiments, the rank is determined independent of a quantification of an extent the topic is covered in the transcript 108. The ranker 224 is discussed in more detail regarding FIG. 2. The ranker 224 can provide a score for each of the top events 234 (sometimes called a topic), the top events 234 in rank order, or a combination thereof.

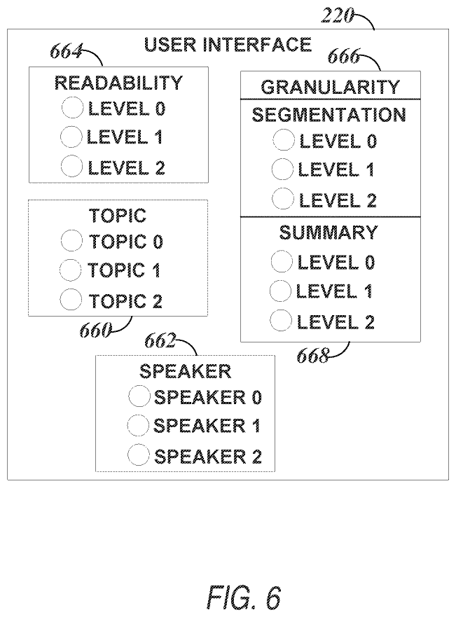

FIG. 6 illustrates, by way of example, a diagram of an embodiment of the user interface 220. The user 112 can adjust format and content of the summary 236 by selecting different controls on the user interface 220. The user interface 220 as illustrated includes a topic software control 660, speaker software control 662, readability software control 664, segmentation granularity software control 666, and a summary granularity software control 668. The user interface 220 converts input received therethrough to the hints 442 used by the summarizer 222 to generate the transcript summary 236.

The topic software control 660 lists topics (e.g., top events 234). The topic software control 660 can include an input box through which the user 112 can specify a topic that is not listed in the topic software control 660. While three topics are listed, more or fewer topics can be listed. Also, while radio buttons are illustrated, another selection mechanism can be used, such as a checkbox, drop-down menu, or the like.

The speaker software control 662 lists identifications of people who spoke in the conference and whose utterances are memorialized in the transcript 108. The speaker software control 662 can include an input box through which the user 112 can specify a speaker that is not listed in the speaker software control 662. While three speakers are listed, more or fewer speakers can be listed. Also, while radio buttons are illustrated, another selection mechanism can be used, such as a checkbox, drop-down menu, or the like.

The readability software control 664 lists levels of readability. The levels of the readability software control 664 indicate different levels of processing to be performed on the transcript 108 in generating the summary 236. For example, level 0 can be the raw transcript 108, level 1 can be the raw transcript 108 with filler words removed, level 2 can be the raw transcript 108 with the filler words removed and the transcript 108 segmented into different event spans. While three levels are listed, more or fewer levels can be listed. Also, while radio buttons are illustrated, another selection mechanism can be used, such as a checkbox, drop-down menu, or the like.

The segmentation granularity software control 666 lists selectable levels of segmentation granularity. The levels of the segmentation granularity software control 666 indicate different levels of processing to be performed on the transcript 108 in generating the summary 236. For example, the higher the level, the more fine-grained the summary 236 produced. For example, for level 0 a first specified number (or percentage) of events 234 can be selected and summarized, for level 1 a second specified number (or percentage) of events 234 can be selected and summarized, and for level 2 a third specified number (or percentage) of events 234 can be selected and summarized. The third specified number is greater than the second specified number, which is greater than the first specified number. While three levels are listed, more or fewer levels can be listed. Also, while radio buttons are illustrated, another selection mechanism can be used, such as a checkbox, drop-down menu, or the like.

The summary granularity software control 666 lists selectable levels of summary granularity. The levels of the summary granularity software control 666 indicate different levels of detail that is provided for each topic in the summary 236. For example, the higher the level, the more detailed the summary 236 produced. For example, for level 0 a first specified number of sentences, words, or phrases can be used for each event in the summary, for level 1 a second specified number of sentences, words, or phrases can be used for each event in the summary, and for level 2 a third specified number of sentences, words, or phrases can be used for each event in the summary. The third specified number is greater than the second specified number, which is greater than the first specified number. While three levels are listed, more or fewer levels can be listed. Also, while radio buttons are illustrated, another selection mechanism can be used, such as a checkbox, drop-down menu, or the like.

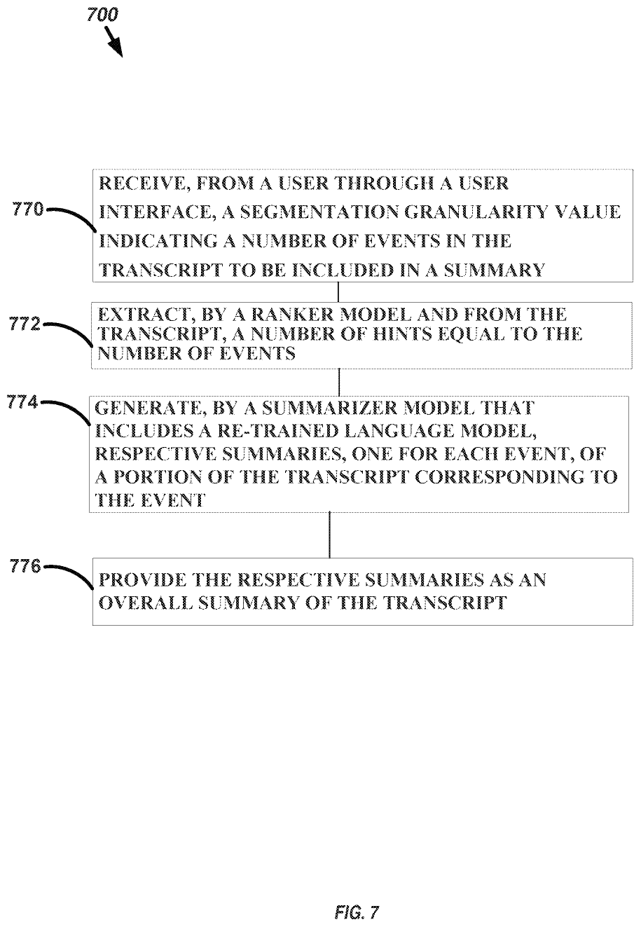

FIG. 7 illustrates, by way of example, a diagram of an embodiment of a method 700 for. The method 700 as illustrated includes receiving, from a user through a user interface, a segmentation granularity value indicating a number of events in the transcript to be included in a summary, at operation 770; extracting, by a ranker model and from the transcript, a number of hints equal to the number of events, at operation 772; generating, by a summarizer model that includes a re-trained language model, respective summaries, one for each event, of a portion of the transcript corresponding to the event, at operation 774; and providing the respective summaries as an overall summary of the transcript, at operation 776.

The method 700 can further include receiving, from the user through the user interface, a summary granularity value indicating a length of each of the respective summaries. The method 700 can further include, wherein the respective summaries are generated, by the summarizer model and based on the summary granularity value, to have a length consistent with the summary granularity value. The method 700 can further include receiving, from the user through the user interface, topic data indicating one or more events to be summarized. The method 700 can further include, wherein the respective summaries are generated, by the summarizer model and based on the topic data, to cover the events indicated by the topic data.

The method 700 can further include receiving, from the user through the user interface, speaker data indicating one or more speakers to be summarized. The method 700 can further include, wherein the respective summaries are generated, by the summarizer model and based on the speaker data, to cover utterances made by the one or more speakers indicated by the speaker data. The method 700 can further include receiving, from the user through the user interface, readability data indicating how fluent the overall summary is to be. The method 700 can further include wherein the respective summaries are generated, by the summarizer model, to be readable at a level indicated by the readability data. The method 700 can further include, wherein the readability data indicates whether to remove filler words by identification and masking and whether to segment the transcript based on a ranking of the events.

The method 700 can further include, wherein the summarizer model is trained by masking keywords in the transcript and having the summarizer model generate an unmasked transcript that fills in the masked keywords. The method 700 can further include adjusting weights of the summarizer model based on differences between the transcript and the unmasked transcript to generate a pre-trained summarizer model. The method 700 can further include fine-tuning the pre-trained summarizer model based on hints, the transcript, and pre-generated summaries. The method 700 can further include, wherein the hints include two or more of readability data, topic data, speaker data, summary granularity value, and segmentation granularity value.

An Example transcript and corresponding summaries of different granularities are provided.

Consider the following transcript:

### [Begin Transcript]

Turn 0: User Interface Designer: Okay.
. . . .
Turn 243: Project Manager: Well, this uh this tool seemed to work.
. . . .
Turn 257: Project Manager: More interesting for our company of course, uh profit aim, about fifty million Euro. So, we have to sell uh quite a lot of this uh things. . . . .
Turn 258: User Interface Designer: Ah yeah, the sale man, four million.
Turn 259: User Interface Designer: Maybe some uh Asian countries. Um also important for you all is um the production cost must be maximal uh twelve uh twelve Euro and fifty cents.
. . . .
Turn 275: Project Manager: So uh well I think when we are working on the international market, uh in principle it has enough customers.
Turn 276: Industrial Designer: Yeah.
Turn 277: Project Manager: Uh so when we have a good product, we uh we could uh meet this this aim, I think. So, that about finance. And uh now just let have some discussion about what a good remote control is and uh well keep in mind this this first point, it has to be original, it has to be trendy, it has to be user friendly.
. . . .
Turn 400: Project Manager: Keep it in mind it's a twenty-five Euro unit, so uh uh the very fancy stuff we can leave that out, I think.

### [End of Transcript]

The “turn” indicates order of the utterances, with a lower number meaning an utterance earlier in time. The summarizer 222 can generate the following summaries at different summary granularities:

Summary at summary granularity Level 1:
“Cost constraints and financial targets; Remote control features”

Summary at summary granularity Level 2:
“Project Manager introduced the financial information.
User Interface Designer and Industrial Designer expressed a desire to integrate cutting-edge features into the remote control,”

Summary at summary granularity Level 3:
“Project Manager introduced the financial information, and the product would be priced at 25 Euros and the cost of 12.5 Euros.

User Interface Designer and Industrial Designer expressed a desire to integrate cutting-edge features into the remote control, while marketing believed that fancy features should be left out.”

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as text prediction, toxicity classification, content filtering, or the like, Each of the summarizer 222 and ranker 224 can include one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

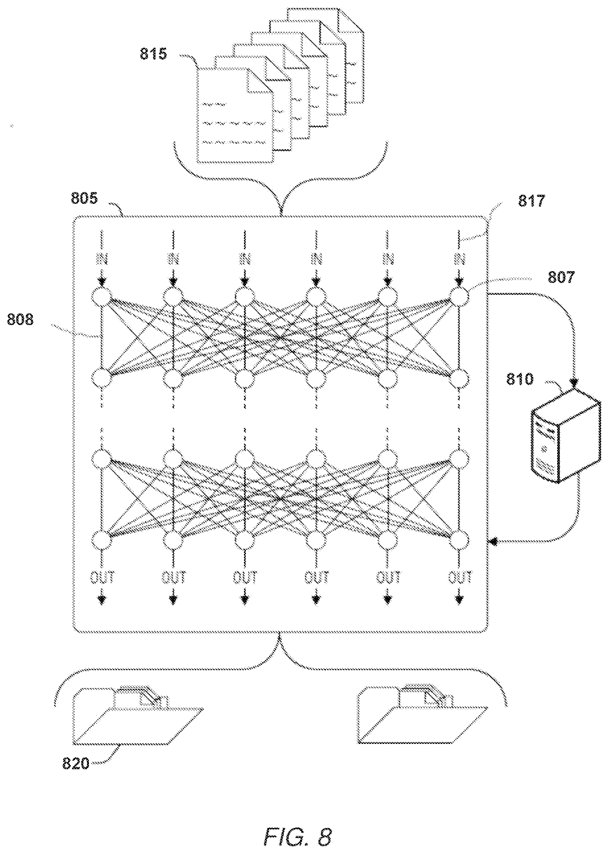

FIG. 8 is a block diagram of an example of an environment including a system for neural network training. The system includes an artificial NN (ANN) 805 that is trained using a processing node 810. The processing node 810 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 805, or even different nodes 807 within layers. Thus, a set of processing nodes 810 is arranged to perform the training of the ANN 805.

The set of processing nodes 810 is arranged to receive a training set 815 for the ANN 805. The ANN 805 comprises a set of nodes 807 arranged in layers (illustrated as rows of nodes 807) and a set of inter-node weights 808 (e.g., parameters) between nodes in the set of nodes. In an example, the training set 815 is a subset of a complete training set. Here, the subset may enable processing nodes with limited storage resources to participate in training the ANN 805.

The training data may include multiple numerical values representative of a domain, such as a word, symbol, number, other part of speech, or the like. Each value of the training or input 817 to be classified after ANN 805 is trained, is provided to a corresponding node 807 in the first layer or input layer of ANN 805. The values propagate through the layers and are changed by the objective function.

As noted, the set of processing nodes is arranged to train the neural network to create a trained neural network. After the ANN is trained, data input into the ANN will produce valid classifications 820 (e.g., the input data 817 will be assigned into categories), for example. The training performed by the set of processing nodes 807 is iterative. In an example, each iteration of the training the ANN 805 is performed independently between layers of the ANN 805. Thus, two distinct layers may be processed in parallel by different members of the set of processing nodes. In an example, different layers of the ANN 805 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 807 (e.g., neurons) are trained independently. In an example, the nodes are trained on different hardware.

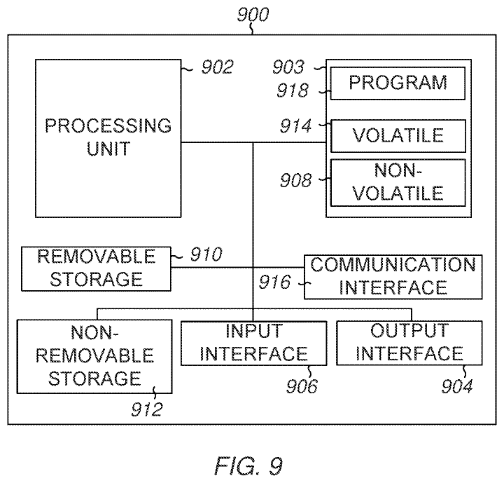

FIG. 9 illustrates, by way of example, a block diagram of an embodiment of a machine 900 (e.g., a computer system) to implement one or more embodiments. The client device 102, 104, conference platform 106, speech-to-text model 110, user interface 220, ranker 224, summarizer 222, or a component thereof can include one or more of the components of the machine 900. One or more of the client device 102, 104, conference platform 106, speech-to-text model 110, user interface 220, ranker 224, summarizer 222, or a component or operations thereof can be implemented, at least in part, using a component of the machine 900. One example machine 900 (in the form of a computer), may include a processing unit 902, memory 903, removable storage 910, and non-removable storage 912. Although the example computing device is illustrated and described as machine 900, the computing device may be in different forms in different embodiments. For example, the computing device may instead be a smartphone, a tablet, smartwatch, or other computing device including the same or similar elements as illustrated and described regarding FIG. 9. Devices such as smartphones, tablets, and smartwatches are generally collectively referred to as mobile devices. Further, although the various data storage elements are illustrated as part of the machine 900, the storage may also or alternatively include cloud-based storage accessible via a network, such as the Internet.

Memory 903 may include volatile memory 914 and non-volatile memory 908. The machine 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 900 may include or have access to a computing environment that includes input 906, output 904, and a communication connection 916. Output 904 may include a display device, such as a touchscreen, that also may serve as an input device. The input 906 may include one or more of a touchscreen, touchpad, mouse, keyboard, camera, one or more device-specific buttons, one or more sensors integrated within or coupled via wired or wireless data connections to the machine 900, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks,

Computer-readable instructions stored on a computer-readable storage device are executable by the processing unit 902 (sometimes called processing circuitry) of the machine 900. A hard drive, CD-ROM, and RAM are some examples of articles including a non-transitory computer-readable medium such as a storage device. For example, a computer program 918 may be used to cause processing unit 902 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware-based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on processing circuitry, such as can include a digital signal processor, ASIC, microprocessor, central processing unit (CPU), graphics processing unit (GPU), field programmable gate array (FPGA), or other type of processor operating on a computer system, such as a personal computer, server, or other computer system, turning such computer system into a specifically programmed machine. The processing circuitry can, additionally or alternatively, include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like). The terms computer-readable medium, machine readable medium, and storage device do not include carrier waves or signals to the extent carrier waves and signals are deemed too transitory.

### ADDITIONAL NOTES AND EXAMPLES

Example 1 includes a computer implemented method for generating multi-granularity summarizations of a transcript of a conference, the method comprising receiving, from a user through a user interface, a segmentation granularity value indicating a number of events in the transcript to be included in a summary, extracting, by a ranker model and from the transcript, a number of hints equal to the number of events, generating, by a summarizer model that includes a re-trained language model, respective summaries, one for each event, of a portion of the transcript corresponding to the event, and providing the respective summaries as an overall summary of the transcript.

In Example 2, Example 1 further includes receiving, from the user through the user interface, a summary granularity value indicating a length of each of the respective summaries, and wherein the respective summaries are generated, by the summarizer model and based on the summary granularity value, to have a length consistent with the summary granularity value.

In Example 3, at least one of Examples 1-2, further includes receiving, from the user through the user interface, topic data indicating one or more events to be summarized, and wherein the respective summaries are generated, by the summarizer model and based on the topic data, to cover the events indicated by the topic data.

In Example 4, at least one of Examples 1-3 further includes receiving, from the user through the user interface, speaker data indicating one or more speakers to be summarized, and wherein the respective summaries are generated, by the summarizer model and based on the speaker data, to cover utterances made by the one or more speakers indicated by the speaker data.

In Example 5, at least one of Examples 1-4 further includes receiving, from the user through the user interface, readability data indicating how fluent the overall summary is to be, and wherein the respective summaries are generated, by the summarizer model, to be readable at a level indicated by the readability data.

In Example 6, Example 5 further includes, wherein the readability data indicates whether to remove filler words by identification and masking and whether to segment the transcript based on a ranking of the events.

In Example 7, at least one of Examples 1-6 further includes, wherein the summarizer model is trained by masking keywords in the transcript and having the summarizer model generate an unmasked transcript that fills in the masked keywords, adjusting weights of the summarizer model based on differences between the transcript and the unmasked transcript to generate a pre-trained summarizer model, and fine-tuning the pre-trained summarizer model based on hints, the transcript, and pre-generated summaries.

In Example 8, Example 7 further includes, wherein the hints include two or more of readability data, topic data, speaker data, summary granularity value, and segmentation granularity value.

Example 9 includes a compute system comprising a memory, processing circuitry coupled to the memory, the processing circuitry configured to perform the operations of the method of at least one of Examples 1-8.

Example 10 includes a machine-readable medium including instructions that, when executed by a machine, cause the machine to perform operations of the method of at least one of Examples 1-8.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer implemented method for generating multi-granularity summarizations of a transcript of a conference, the method comprising:
receiving, from a user through a user interface, a segmentation granularity value indicating a number of events in the transcript to be included in a summary;
extracting, by a ranker model and from the transcript, a number of hints equal to the number of events;
generating, by a summarizer model that includes a re-trained language model, respective summaries, one for each event, of a portion of the transcript corresponding to the event; and
providing the respective summaries as an overall summary of the transcript.

2. The method of claim 1, further comprising:
receiving, from the user through the user interface, a summary granularity value indicating a length of each of the respective summaries; and
wherein the respective summaries are generated, by the summarizer model and based on the summary granularity value, to have a length consistent with the summary granularity value.

3. The method of claim 1, further comprising:
receiving, from the user through the user interface, topic data indicating one or more events to be summarized; and
wherein the respective summaries are generated, by the summarizer model and based on the topic data, to cover the events indicated by the topic data.

4. The method of claim 1, further comprising:
receiving, from the user through the user interface, speaker data indicating one or more speakers to be summarized; and
wherein the respective summaries are generated, by the summarizer model and based on the speaker data, to cover utterances made by the one or more speakers indicated by the speaker data.

5. The method of claim 1, further comprising:
receiving, from the user through the user interface, readability data indicating how fluent the overall summary is to be; and
wherein the respective summaries are generated, by the summarizer model, to be readable at a level indicated by the readability data.

6. The method of claim 5, wherein the readability data indicates whether to remove filler words by identification and masking and whether to segment the transcript based on a ranking of the events.

7. The method of claim 1, wherein the summarizer model is trained by:
masking keywords in the transcript and having the summarizer model generate an unmasked transcript that fills in the masked keywords;
adjusting weights of the summarizer model based on differences between the transcript and the unmasked transcript to generate a pre-trained summarizer model; and
fine-tuning the pre-trained summarizer model based on hints, the transcript, and pre-generated summaries.

8. The method of claim 7, wherein the hints include two or more of readability data, topic data, speaker data, summary granularity value, and segmentation granularity value.

9. A system for multi-granularity meeting summarization, the system comprising:
processing circuitry;
a memory including instructions that, when executed by the processing circuitry, cause the processing circuitry to perform operations for multi-granularity meeting summarization, the operations comprising:
receiving, from a user through a user interface, a segmentation granularity value indicating a number of events in the transcript to be included in a summary;
extracting, by a ranker model and from the transcript, a number of hints equal to the number of events;
generating, by a summarizer model that includes a re-trained language model, respective summaries, one for each event, of a portion of the transcript corresponding to the event; and
providing the respective summaries as an overall summary of the transcript.

10. The system of claim 9, wherein the operations further comprise:
receiving, from the user through the user interface, a summary granularity value indicating a length of each of the respective summaries; and
wherein the respective summaries are generated, by the summarizer model and based on the summary granularity value, to have a length consistent with the summary granularity value.

11. The system of claim 9, wherein the operations further comprise:
receiving, from the user through the user interface, topic data indicating one or more events to be summarized; and
wherein the respective summaries are generated, by the summarizer model and based on the topic data, to cover the events indicated by the topic data.

12. The system of claim 9, wherein the operations further comprise:
receiving, from the user through the user interface, speaker data indicating one or more speakers to be summarized; and
wherein the respective summaries are generated, by the summarizer model and based on the speaker data, to cover utterances made by the one or more speakers indicated by the speaker data.

13. The system of claim 9, wherein the operations further comprise:
receiving, from the user through the user interface, readability data indicating how fluent the overall summary is to be; and
wherein the respective summaries are generated, by the summarizer model, to be readable at a level indicated by the readability data.

14. The system of claim 13, wherein the readability data indicates whether to remove filler words by identification and masking and whether to segment the transcript based on a ranking of the events.

15. The system of claim 9, wherein the summarizer model is trained by:
masking keywords in the transcript and having the summarizer model generate an unmasked transcript that fills in the masked keywords;
adjusting weights of the summarizer model based on differences between the transcript and the unmasked transcript to generate a pre-trained summarizer model; and
fine-tuning the pre-trained summarizer model based on hints, the transcript, and pre-generated summaries.

16. The system of claim 15, wherein the hints include two or more of readability data, topic data, speaker data, summary granularity value, and segmentation granularity value,

17. A machine-readable medium including instructions that, when executed by a machine, cause the machine to perform operations for multi-granularity transcript summarization, the operations comprising:
receiving, from a user through a user interface, a segmentation granularity value indicating a number of events in the transcript to be included in a summary;
extracting, by a ranker model and from the transcript, a number of hints equal to the number of events;
generating, by a summarizer model that includes a re-trained language model, respective summaries, one for each event, of a portion of the transcript corresponding to the event; and
providing the respective summaries as an overall summary of the transcript.

18. The machine-readable medium of claim 17, wherein the operations further comprise:
receiving, from the user through the user interface, a summary granularity value indicating a length of each of the respective summaries; and
wherein the respective summaries are generated, by the summarizer model and based on the summary granularity value, to have a length consistent with the summary granularity value.

19. The machine-readable medium of claim 17, wherein the operations further comprise:
receiving, from the user through the user interface, topic data indicating one or more events to be summarized; and
wherein the respective summaries are generated, by the summarizer model and based on the topic data, to cover the events indicated by the topic data.

20. The machine-readable of claim 17, wherein the operations further comprise:
receiving, from the user through the user interface, speaker data indicating one or more speakers to be summarized; and
wherein the respective summaries are generated, by the summarizer model and based on the speaker data, to cover utterances made by the one or more speakers indicated by the speaker data.
